(19) United States
(12) Patent Application Publication
(10) Pub. No.: US 2026/0351589 A1
(43) Pub. Date: Nov. 5, 2026

(54) POSITIVE ELECTRODE ACTIVE MATERIAL AND METHOD FOR MANUFACTURING A POSITIVE ELECTRODE ACTIVE MATERIAL

(71) Applicant: Umicore, Brussels (BE)

(72) Inventors: Shinichi KUMAKURA, Olen (BE); TaeHyeon YANG, Chungcheongnam-do (KR); Esther BREUGELMANS, Olen (BE)

(21) Appl. No.: 19/119,940

(22) PCT Filed: Oct. 13, 2023
(86) PCT No.: PCT/EP2023/078451

§ 371 Date: Apr. 10, 2025

(30) Foreign Application Priority Data
Oct. 14, 2022 (EP) 22201666.9

(51) Int. Cl. H01M 4/525; C01G 53/506; H01M 10/0525; H01M 10/0562

(52) U.S. Cl. CPC H01M 4/525; C01G 53/506; H01M 10/0525; H01M 10/0562; C01P 2002/54; C01P 2002/85; C01P 2006/40; H01M 2300/008

(57) ABSTRACT

The present invention relates to a positive electrode active material for solid-state batteries, wherein the positive electrode active material comprises Li, M′, and oxygen, wherein M′ comprises Ti. The present inventors have surprisingly found that the positive electrode active material of the invention increases the cycling efficiency of the battery, in particular a sulfide solid-state battery, significantly.

### TECHNICAL FIELD AND BACKGROUND

The present invention relates to a positive electrode active material for solid-state batteries, wherein the positive electrode active material comprises Li, M′, and oxygen, wherein M′ comprises Ti. This invention also relates to the method of manufacturing said positive electrode active material, the solid-state battery comprising said positive electrode active material and the use of said solid-state battery.

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to a high energy density and a high reference electrode potential.

During the charging process of a secondary battery, lithium ions are removed from the cathode, transported through the electrolyte, and are inserted into the anode while electrons are removed from the cathode and injected into the anode through an external circuit (charger). During the use or discharge of a secondary battery, lithium ions are removed from the anode, transported through the electrolyte, and are inserted into the cathode, while electrons flow through an external circuit to provide electric work.

Commonly used cathode active materials are lithium transition metal oxides. During the charging and/or discharging of the lilium battery, the delithiated cathode active material can slowly react with the non-aqueous electrolyte or the solid electrolyte leading to a gradual degradation of the electrochemical performance of lithium batteries using such cathode active materials. It has been demonstrated that treatment of the cathode active material with metals, such as Ti or Zr, (i.e. applying a thin surface layer of the metal on the cathode active material resulting in an increased amount of said metals in the surface layer) results in a cathode active material exhibiting a higher stability as compared to their counterparts devoid of such a surface layer.

CN109742376A discloses a Ti-treated positive electrode active material containing 83% nickel, 5% manganese and 12% cobalt, wherein the positive electrode active material is obtained after dry treatment of the positive electrode active material with 0.1 wt. % TiO₂.

US2019/0006662A1 contemplates Ti-treated positive electrode active material containing 60% nickel, 20% manganese and 20% cobalt, wherein the treated positive electrode active material is obtained after treatment of the positive electrode active material with titanium butoxide in EtOH.

A drawback related to these known Ti-treated positive electrode active material is the low cycling efficiency and/or low first discharge capacity of the battery containing said Ti-treated positive electrode active material. Hence, there remains a need to provide a positive electrode active material having an enriched amount of Ti in the surface layer to improve the cycling efficiency of the resulting battery.

It is an object of the present invention to provide a positive electrode active material having an enriched amount of Ti in the surface layer, which improves the cycling efficiency of the resulting battery.

It is another object of the present invention to provide a method for manufacturing said positive electrode active material.

It is another object of the present invention to provide a battery comprising said positive electrode active material.

It is another object of the present invention to provide a use of said battery.

### SUMMARY OF THE INVENTION

In a first aspect an object of the invention is achieved by providing a positive electrode active material for solid-state batteries, wherein the positive electrode active material comprises Li, M′, and oxygen, wherein M′ comprises:
Ni in a content x, wherein 55.0 mol %≤x≤98.0 mol %,
Mn in a content y, wherein 0.0 mol %≤y≤45.0 mol %,
Co in a content z, wherein 0.0 mol %≤z≤45.0 mol %,
D in a content a, wherein 0.0 mol %≤a≤5.0 mol %, wherein D is at least one other element than Li, Ni, Mn, Co, Ti and O,
Ti in a content b, wherein 0.01 mol %≤b≤5.0 mol %,
wherein x, y, z, a, and b are measured by ICP-OES,
wherein x+y+z+a+b is 100.0 mol %,
   wherein the positive electrode active material has an enriched amount of Ti in the surface layer.

The present inventors have surprisingly found that the positive electrode active material of the invention increases the cycling efficiency of the battery, in particular a sulfide solid-state battery, significantly. Moreover, the positive electrode active material of the invention displays a high first discharge capacity. Preferably, the treated positive electrode active material comprising polycrystalline particles outperform the corresponding single-crystalline positive electrode active material or positive electrode active material comprising single and/or secondary particles as defined herein in terms of cycling efficiency.

Without wishing to be bound by any theory, the present inventors believe that addition of a Li-source together with a Ti-source as treatment agent is necessary to obtain a lithium titanium oxide compound as an effective treatment on the positive electrode active material.

In a further aspect the invention provides a method for manufacturing said positive electrode active material.

In a further aspect the invention provides a battery comprising said positive electrode active material.

In a further aspect the invention provides a use of said battery.

### DETAILED DESCRIPTION

In the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein and in the claims refers to a cell or a battery that includes only solid or substantially solid-state components such as solid electrodes (e.g. anode and cathode) and a solid electrolyte.

The term “a positive electrode active material” (also known as cathode active material) as used herein and in the claims is defined as a material which is electrochemically active in a positive electrode or cathode. By active material, it must be understood to be a material capable to capture and release Li ions when subjected to a voltage change over a predetermined period of time.

The term “slurry” as used herein and in the claims refers to a mixture, premixture and/or admixture of solid particles suspended in a liquid, such as water, alcohol or combinations thereof. When using the term “slurry” the solid particles are not dissolved or not completely dissolved in the liquid. For example, a slurry of a lithium transition metal-based oxide compound is a suspension of the particles constituting the lithium transition metal-based oxide compound in a liquid. Worded differently, the particles constituting the lithium transition metal-based oxide compound are not dissolved or not completely dissolved in the liquid.

In the context of the present invention the terms “solid” and “liquid” shall be considered to be a solid and liquid in standard conditions for temperature and pressure as defined by the IUPAC, unless defined otherwise. Hereby the boiling point and the melting point shall be considered to be the boiling point and the melting point at standard atmospheric pressure, i.e. at 101325 Pa.

### Positive Electrode Active Material

In a first aspect, the present invention concerns a positive electrode active material for solid-state batteries, wherein the positive electrode active material comprises Li, M′, and oxygen, wherein M′ comprises:
Ni in a content x, wherein 55.0 mol %≤x≤98.0 mol %,
Mn in a content y, wherein 0.0 mol %≤y≤45.0 mol %,
Co in a content z, wherein 0.0 mol %≤z≤45.0 mol %,
D in a content a, wherein 0.0 mol %≤a≤5.0 mol %, wherein D is at least one other element than Li, Ni, Mn, Co, Ti and O,
Ti in a content b, wherein 0.01 mol %≤b≤5.0 mol %,
wherein x, y, z, a, and b are measured by ICP-OES,
wherein x+y+z+a+b is 100.0 mol %.

A certain preferred embodiment is the positive electrode active material of the invention, wherein Ni is in a content x≥60.0 mol %, preferably x≥61.0 mol %, more preferably x≥62.0 mol %. In a certain preferred embodiment Ni is in a content x≤90.0 mol % preferably x≤88 mol % and more preferably x≤85.0 mol %. A more certain preferred embodiment is the positive electrode active material of the invention, wherein Ni is in a content x between 55.0 mol %≤x≤75.0 mol %, preferably 60.0 mol %≤x≤70.0 mol %, more preferably 62.0 mol %≤x≤68.0 mol %. Another more certain preferred embodiment is the positive electrode active material of the invention, wherein Ni is in a content x between 60.0 mol %≤x≤90.0 mol %, preferably 61.0 mol %≤x≤88.0 mol %, more preferably 62.0 mol %≤x≤85.0 mol %.

A more preferred certain embodiment is the positive electrode active material of the invention, wherein Ni is in a content x>75.0 mol %, preferably x≥76.0 mol %, more preferably x≥77.0 mol % A more preferred certain embodiment is the positive electrode active material of the invention, wherein Ni is in a content x between x≤95.0 mol %, preferably ≤x≤90.0 mol %, more preferably x≤88.0 mol %. A more preferred certain embodiment is the positive electrode active material of the invention, wherein Ni is in a content x between 75.0 mol %<x≤95.0 mol %, preferably 76.0 mol %≤x≤90.0 mol %, more preferably 77.0 mol %≤x≤88.0 mol %.

As appreciated by the skilled person the amount of Li and M′, preferably Li, Ni, Mn, Co, D and Ti in the positive electrode active material is measured by Inductively Coupled Plasma Optical Emission Spectroscopy (ICP-OES). For example, but not limiting to the invention, an Agilent ICP 720-ES is used in the ICP-OES analysis.

A preferred embodiment is the positive electrode active material of the invention, wherein Mn is in a content y>0.0 mol %, preferably y≥3.0 mol %, more preferably y≥5.0 mol %. In a preferred embodiment the content is y≤30.0 mol %, preferably y≤20.0 mol %, and more preferably y≤15.0 mol %. In a preferred embodiment Mn is in a content 0.0 mol %<y≤30.0 mol %, preferably 3.0 mol %≤y≤20.0 mol %, more preferably 5.0 mol %≤y≤15.0 mol %.

A preferred embodiment is the positive electrode active material of the invention, wherein Co is in a content z>0.0 mol %, preferably z≥1.0 mol %, more preferably z≥3.0 mol %. In a preferred embodiment the content z≤30.0 mol %, preferably z≤20.0 mol %, more preferably z≤15.0 mol %. In a preferred embodiment the content is 0.0 mol %<z≤30.0 mol %, preferably 1.0 mol %≤z≤20.0 mol %, more preferably 3.0 mol %≤z≤15.0 mol %.

As is known to the skilled person, the positive electrode active material of the invention can comprise impurities or be doped or added to the surface layer resulting in an overall positive electrode active material comprising one or more elements other than Li, Ni, Mn, Co, Ti and O, which is reflected in the parameter “D” used herein. A preferred embodiment is the positive electrode active material according to the invention comprising D, wherein D is at least one element selected from the group consisting of Al, B, Ba, Ca, Cr, Fe, Mg, Mo, Nb, S, Si, Sr, V, W, Y, Zn, and Zr; preferably Al, B, Cr, Nb, S, Si, Y, Zr and W; more preferably B, Nb, Zr and W.

A preferred embodiment is the positive electrode active material according to the invention, wherein D is in a content a>0.0 mol %, preferably a≥0.25 mol %, more preferably a≥0.5 mol %. In a preferred embodiment the content a≤2.0 mol %, preferably a≤1.75 mol %, more preferably a≤1.5 mol %. In a preferred embodiment the content is 0.0 mol %<a≤2.0 mol %, preferably 0.25 mol %≤a≤1.75 mol %, more preferably 0.5 mol %≤a≤1.5 mol %.

A preferred embodiment is the positive electrode active material of the invention, wherein Ti is in a content b≥0.01 mol %, preferably b≥0.05 mol %, more preferably b≥0.10 mol %. In a preferred embodiment b≤2.5 mol %, preferably b≤2.0 mol %, more preferably b≤1.0 mol %. In a preferred embodiment 0.01 mol %≤b≤2.5 mol %, preferably 0.05 mol %≤b≤2.0 mol %, more preferably 0.10 mol %≤b≤1.0 mol %.

A preferred embodiment is the positive electrode active material of the invention having a carbon content of higher than 0.020 wt. % by total weight of the positive electrode active material, preferably a carbon content higher than 0.030 wt. %, more preferably a carbon content higher than 0.045 wt. % by total weight of the positive electrode active material. A preferred embodiment is the positive electrode active material of the invention having a carbon content of less than 0.10 wt. % by total weight of the positive electrode active material, preferably a carbon content less than 0.080 wt. %, more preferably a carbon content less than 0.065 wt. % by total weight of the positive electrode active material. A preferred embodiment is the positive electrode active material of the invention having a carbon content in the range of 0.020 wt. % and 0.10 wt. % by total weight of the positive electrode active material, preferably a carbon content in the range of 0.030 wt. % and 0.080 wt. %, more preferably a carbon content in the range of 0.045 wt. % 0.065 wt. % by total weight of the positive electrode active material. As appreciated by the skilled person the carbon content can be analyzed with a carbon analyzer. For example, but not limiting to the invention, a Horiba Emia-Expert carbon/sulfur analyzer can be used.

A preferred embodiment is the positive electrode active material of the invention having a Li/M′ ratio, preferably a Li/(Ni+Mn+Co) ratio, >0.90, preferably >0.92, more preferably >0.95. A preferred embodiment is the positive electrode active material of the invention having a Li/M′ ratio, preferably a Li/(Ni+Mn+Co) ratio, <1.10, preferably <1.08, more preferably <1.05. A preferred embodiment is the positive electrode active material of the invention having a Li/M′ ratio, preferably a Li/(Ni+Mn+Co) ratio, in the range of 0.90-1.10, preferably in the range of 0.92-1.08, more preferably in the range of 0.95-1.05. As appreciated by the skilled person the Li/M′ ratio, preferably the Li/(Ni+Mn+Co) ratio, is a molar ratio (mol/mol).

In a highly preferred embodiment the positive electrode active material is according to formula Li_{w2}Niₓ₂Mn_{y2}CO_{z2}Dₐ₂Ti_{b2}O₂, wherein 0.90≤w2≤1.10, preferably 0.92≤w2≤1.1, more preferably 0.95≤w2≤1.05; 0.55≤x2≤0.98, preferably 0.60≤x2≤0.88, more preferably 0.65≤x2≤0.85; 0.0≤y2≤0.45, preferably 0.03≤y2≤0.20, more preferably 0.05≤y2≤0.10; 0.0≤z2≤0.45, preferably 0.03≤z2≤0.20, more preferably 0.05≤z2≤0.10; 0.0≤a2≤0.02, preferably 0.025≤a2≤0.0175, more preferably 0.005≤a2≤0.015; 0.001≤b2≤0.025, preferably 0.005≤b2≤0.02, more preferably 0.01≤b2≤0.1, wherein x2+y2+z2+a2+b2=1.00.

In highly preferred embodiments 0.99≤w2≤1.01, preferably w2 is about 1.00.

In highly preferred embodiments 0.75≤x2≤0.85, preferably 0.80≤x2≤0.85, more preferably x2 is about 0.83.

In highly preferred embodiments 0.06≤y2≤0.08, preferably y2 is about 0.07.

In highly preferred embodiments 0.08≤z2≤0.10, preferably z2 is about 0.09.

In highly preferred embodiments 0.0≤a2≤0.01, preferably a2 is about 0.0.

In highly preferred embodiments 0.01≤b2≤0.05, preferably b2 is about 0.01.

### Surface Layer

A preferred embodiment concerns the positive electrode active material of the invention, wherein the positive electrode active material has a Ti content Ti_{A} defined as

$$\frac{b}{( x + y + z + b )}$$

and wherein the positive electrode active material has a Ti content Ti_{B}, wherein Ti_{B} is determined by XPS analysis, wherein Ti_{B} is expressed as a molar fraction compared to the sum of molar fractions of Co, Mn, Ni and Ti as measured by XPS analysis, wherein the ratio Ti_{B}/Ti_{A}>25.0. A more preferred embodiment concerns the positive electrode active material of the invention, wherein the ratio Ti_{B}/Ti_{A}>50.0, preferably the ratio Ti_{B}/Ti_{A}>75.0, more preferably the ratio Ti_{B}/Ti_{A}>100.0, even more preferably the ratio Ti_{B}/Ti_{A}>125.0, most preferably the ratio Ti_{B}/Ti_{A}>150.0.

A more preferred embodiment concerns the positive electrode active material of the invention, wherein the ratio Ti_{B}/Ti_{A}<1250.0, preferably the ratio Ti_{B}/Ti_{A}<1000.0, more preferably the ratio Ti_{B}/Ti_{A}<750.0, even more preferably the ratio Ti_{B}/Ti_{A}<500.0, most preferably the ratio Ti_{B}/Ti_{A}<250.0.

A more preferred embodiment concerns the positive electrode active material of the invention, wherein the ratio Ti_{B}/Ti_{A} is in the range of 50.0 and 1000, preferably the ratio Ti_{B}/Ti_{A} is in the rage of 75.0 and 500.0, more preferably the ratio Ti_{B}/Ti_{A} is in the range of 100.0 and 250.0.

In the context of the present invention, Ti_{B} is the molar fraction of Ti measured in a region of a particle of the positive electrode active material according to invention defined between a first point of an external edge of said particle and a second point at a distance from said first point. Said distance separating said first to said second point being equal to a penetration depth of said XPS, said penetration depth D′ being comprised between 1.0 to 10.0 nm. In particular, the penetration depth is the distance along an axis perpendicular to a virtual line tangent to said external edge and passing trough said first point.

The external edge of the particle is, in the framework of this invention, the boundary or external limit distinguishing the particle from its external environment. Therefore, XPS analysis provides atomic content of elements in an uppermost layer of a particle with a penetration depth of about 10.0 nm from an outer boundary of the particle. The outer boundary of the particle is also referred to as “surface”. For example, but not limiting to the invention, XPS analysis is carried out with a Thermo K−α+ spectrometer (Thermo Scientific).

In the framework of the present invention, at % signifies atomic percentage. The at % or “atomic percent” of a given element expression of a concentration means how many percent of all atoms in the concerned compound are atoms of said element. Further in the framework of the present invention the designation at % is equivalent to mol % or “molar percent”.

As appreciated by the skilled person the defined ratio Ti_{B}/Ti_{A} refers to the positive electrode active material of the invention having an enriched amount of Ti in the surface layer of the positive electrode active material. The surface layer of the positive electrode active material is 1 to 10 nm of the uppermost part of the positive electrode active material. Worded differently, the positive electrode active material of the invention comprises a surface layer of Ti.

In the context of the present invention the positive electrode active material may comprise a first surface layer comprising D, wherein D is at least one element selected from the group consisting of Al, B, Ba, Ca, Cr, Fe, Mg, Mo, Nb, S, Si, Sr, V, W, Y, Zn, and Zr; preferably Al, B, Cr, Nb, S, Si, Y, Zr and W; more preferably B, Nb, Zr and W, wherein the surface layer of Ti may be placed on the first surface layer and/or the first surface layer may be placed on the surface layer of Ti and/or the positive electrode active layer may comprise a mixed surface layer comprising the surface layer of Ti and the first surface layer.

A preferred embodiment concerns the positive electrode active material of the invention, wherein the positive electrode active material has a Li content Li_{A}, wherein Li_{A} is determined by ICP analysis, wherein Li_{A} is expressed as a molar fraction compared to the sum of molar fractions of Co, Mn, Ni, and Ti as measured by ICP analysis and wherein the positive electrode active material has a Li content Lis, wherein Li_{B} is determined by XPS analysis, wherein Li_{B} is expressed as a molar fraction compared to the sum of molar fractions of Co, Mn, Ni, and Ti as measured by XPS analysis.

A preferred embodiment concerns the positive electrode active material of the invention, wherein the ratio Li_{B}/Li_{A}>1.0.

A more preferred embodiment concerns the positive electrode active material of the invention, wherein the ratio Li_{B}/Li_{A}>2.0, preferably the ratio Li_{B}/Li_{A}>2.5, more preferably the ratio Li_{B}/Li_{A}>3.0, even more preferably the ratio Li_{B}/Li_{A}>3.5, most preferably the ratio Li_{b}/Li_{A}>4.0.

A more preferred embodiment concerns the positive electrode active material of the invention, wherein the ratio Li_{b}/Li_{A}<60.0, preferably the ratio Li_{B}/Li_{A}<45.0, more preferably the ratio Li_{B}/Li_{A}<30.0, even more preferably the ratio Li_{B}/Li_{A}<20.0, most preferably the ratio Li_{B}/Li_{A}<10.0.

A more preferred embodiment concerns the positive electrode active material of the invention, wherein the ratio Li_{b}/Li_{A} is between 2.0 and 60.0, preferably the ratio Li_{B}/Li_{A} is between 3.0 and 30.0, more preferably the ratio Li_{B}/Li_{A} is between 4.0 and 10.0.

In the context of the present invention, Lis is the molar fraction of Li measured in a region of a particle of the positive electrode active material according to invention defined between a first point of an external edge of said particle and a second point at a distance from said first point. Said distance separating said first to said second point being equal to a penetration depth of said XPS, said penetration depth D′ being comprised between 1.0 to 10.0 nm. In particular, the penetration depth is the distance along an axis perpendicular to a virtual line tangent to said external edge and passing trough said first point.

As appreciated by the skilled person the defined ratio Li_{b}/Li_{A} refers to the positive electrode active material of the invention having an enriched amount of Li in the surface layer of the positive electrode active material. The surface layer of the positive electrode active material is 1 to 10 nm of the uppermost part of the positive electrode active material. Worded differently, the positive electrode active material of the invention comprises a surface layer of Li.

In the context of the present invention the positive electrode active material may comprise a second surface layer comprising D, wherein D is at least one element selected from the group consisting of Al, B, Ba, Ca, Cr, Fe, Mg, Mo, Nb, S, Si, Sr, V, W, Y, Zn, and Zr; preferably Al, B, Cr, Nb, S, Si, Y, Zr and W; more preferably B, Nb, Zr and W, wherein the surface layer of Li may be placed on the second surface layer and/or the second surface layer may be placed on the surface layer of Li and/or the positive electrode active layer may comprise a mixed surface layer comprising the surface layer of Li and the second surface layer.

A preferred embodiment concerns the positive electrode active material of the invention, wherein the ratio Li_{B}/Ti_{B}>1.0.

A more preferred embodiment concerns the positive electrode active material of the invention, wherein the ratio Li_{B}/Ti_{B}>2.0, preferably the ratio Li_{B}/Ti_{B}>3.0, more preferably the ratio Li_{B}/Ti_{B}>4.0, even more preferably the ratio Li_{B}/Ti_{B}>5.0, most preferably the ratio Li_{B}/Ti_{B}>6.0.

A more preferred embodiment concerns the positive electrode active material of the invention, wherein the ratio Li_{b}/Ti_{B}<100.0, preferably the ratio Li_{B}/Ti_{B}<60.0, more preferably the ratio Li_{B}/Ti_{B}<45.0, even more preferably the ratio Li_{B}/Ti_{B}<30.0, most preferably the ratio Li_{B}/Ti_{B}<10.0.

A more preferred embodiment concerns the positive electrode active material of the invention, wherein the ratio Li_{B}/Ti_{B} is between 2.0 and 60.0, preferably the ratio Li_{B}/Ti_{B} is between 4.0 and 30.0, more preferably the ratio Li_{b}/Ti_{B} is between 6.0 and 10.0.

As appreciated by the skilled person the defined ratio Li_{B}/Ti_{B} refers to the positive electrode active material of the invention having a specific amount of Li and Ti in the surface layer of the positive electrode active material. The surface layer of the positive electrode active material is 1 to 10 nm of the uppermost part of the positive electrode active material.

In the context of the present invention the positive electrode active material may comprise a third surface layer comprising D, wherein D is at least one element selected from the group consisting of Al, B, Ba, Ca, Cr, Fe, Mg, Mo, Nb, S, Si, Sr, V, W, Y, Zn, and Zr; preferably Al, B, Cr, Nb, S, Si, Y, Zr and W; more preferably B, Nb, Zr and W, wherein the surface layer of Ti and Li may be placed on the third surface layer and/or the third surface layer may be placed on the surface layer of Ti and Li and/or the positive electrode active layer may comprise a mixed surface layer comprising the surface layer of Ti and Li and the third surface layer.

Certain preferred embodiments concern the positive electrode active material of the invention, wherein
the ratio Ti_{B}/Ti_{A}>25.0, and
the ratio Li_{b}/Li_{A}>1.0.

Certain preferred embodiments concern the positive electrode active material of the invention, wherein
the ratio Ti_{B}/Ti_{A}>50.0, preferably the ratio Ti_{B}/Ti_{A}>75.0, more preferably the ratio Ti_{B}/Ti_{A}>100.0; and
the ratio Li_{B}/Li_{A}>2.0, preferably the ratio Li_{B}/Li_{A}>3.0, more preferably the ratio Li_{B}/Li_{A}>4.0.

Certain preferred embodiments concern the positive electrode active material of the invention, wherein the ratio Tig/Ti_{A}<1000.0, preferably the ratio Tig/Ti_{A}<500.0, more preferably the ratio Ti_{B}/Ti_{A}<250.0; and the ratio Li_{B}/Li_{A}<60.0, preferably the ratio Li_{B}/Li_{A}<30.0, more preferably the ratio Li_{B}/Li_{A}<10.0.

Certain preferred embodiments concern the positive electrode active material of the invention, wherein
the ratio Ti_{B}/Ti_{A} is in the range of 50.0 and 1000, preferably the ratio Ti_{B}/Ti_{A} is in the rage of 75.0 and 500.0, more preferably the ratio Ti_{B}/Ti_{A} is in the range of 100.0 and 250.0; and
the ratio Li_{B}/Li_{A} is between 2.0 and 60.0, preferably the ratio Li_{b}/Li_{A} is between 3.0 and 30.0, more preferably the ratio Li_{b}/Li_{A} is between 4.0 and 10.0.

Certain preferred embodiments concern the positive electrode active material of the invention, wherein
the ratio Ti_{B}/Ti_{A}>25.0, and
the ratio Li_{B}/Ti_{B}>1.0.

Certain preferred embodiments concern the positive electrode active material of the invention, wherein
the ratio Ti_{B}/Ti_{A}>50.0, preferably the ratio Tis/Ti_{A}>75.0, more preferably the ratio Ti_{B}/Ti_{A}>100.0; and
the ratio Li_{B}/Ti_{B}>2.0, preferably the ratio Li_{B}/Ti_{B}>4.0, most preferably the ratio Li_{B}/Ti_{B}>6.0.

Certain preferred embodiments concern the positive electrode active material of the invention, wherein
the ratio Ti_{B}/Ti_{A}<1000.0, preferably the ratio Ti_{B}/Ti_{A}<500.0, more preferably the ratio Ti_{B}/Ti_{A}<250.0; and
the ratio Li_{B}/Ti_{B}<100.0, preferably preferably the ratio Li_{B}/Ti_{B}<30.0, more preferably the ratio Li_{B}/Ti_{B}<10.0.

Certain preferred embodiments concern the positive electrode active material of the invention, wherein
the ratio Ti_{B}/Ti_{A} is in the range of 50.0 and 1000, preferably the ratio Ti_{B}/Ti_{A} is in the rage of 75.0 and 500.0 and more preferably the ratio Ti_{B}/Ti_{A} is in the range of 100.0 and 250.0; and
the ratio Li_{B}/Li_{A} is between 2.0 and 60.0, preferably the ratio Li_{b}/Li_{A} is between 3.0 and 30.0, more preferably the ratio Li_{B}/Li_{A} is between 4.0 and 10.0.

Certain preferred embodiments concern the positive electrode active material of the invention, wherein
the ratio Li_{B}/Li_{A}>1.0, and
the ratio Li_{B}/Ti_{B}>1.0.

Certain preferred embodiments concern the positive electrode active material of the invention, wherein
the ratio Li_{B}/Li_{A}>2.0, preferably the ratio Li_{B}/Li_{A}>3.0, more preferably the ratio Li_{B}/Li_{A}>4.0; and
the ratio Li_{B}/Ti_{B}>2.0, preferably the ratio Li_{b}/Ti_{B}>4.0, more preferably the ratio Li_{B}/Ti_{B}>6.0.

Certain preferred embodiments concern the positive electrode active material of the invention, wherein
the ratio the ratio Li_{B}/Li_{A}<60.0, preferably the ratio Li_{B}/Li_{A}<30.0, more preferably the ratio Li_{B}/Li_{A}<10.0; and
the ratio Li_{b}/Ti_{B}<100.0, preferably preferably the ratio Li_{B}/Ti_{B}<30.0, more preferably the ratio Li_{B}/Ti_{B}<10.0.

Certain preferred embodiments concern the positive electrode active material of the invention, wherein
the ratio Li_{B}/Li_{A} is between 2.0 and 60.0, preferably the ratio Li_{b}/Li_{A} is between 3.0 and 30.0, more preferably the ratio Li_{B}/Li_{A} is between 4.0 and 10.0; and
the ratio Li_{B}/Li_{A} is between 2.0 and 60.0, preferably the ratio Li_{B}/Li_{A} is between 3.0 and 30.0, more preferably the ratio Li_{b}/Li_{A} is between 4.0 and 10.0.

Certain preferred embodiments concern the positive electrode active material of the invention, wherein
the ratio Ti_{B}/Ti_{A}>25.0;
the ratio Li_{B}/Li_{A}>1.0, and
the ratio Li_{B}/Ti_{B}>1.0.

Certain preferred embodiments concern the positive electrode active material of the invention, wherein
the ratio Ti_{B}/Ti_{A}>50.0, preferably the ratio Ti_{B}/Ti_{A}>75.0, more preferably the ratio Ti_{B}/Ti_{A}>100.0;
the ratio Li_{B}/Li_{A}>2.0, preferably the ratio Li_{B}/Li_{A}>3.0, more preferably the ratio Li_{B}/Li_{A}>4.0; and
the ratio Li_{B}/Ti_{B}>2.0, preferably the ratio Li_{b}/Ti_{B}>4.0, more preferably the ratio Li_{B}/Ti_{B}>6.0.

Certain preferred embodiments concern the positive electrode active material of the invention, wherein
the ratio Tig/Ti_{A}<1000.0, preferably the ratio Ti_{B}/Ti_{B}<500.0, more preferably the ratio Ti_{B}/Ti_{A}<250.0;
the ratio Li_{B}/Li_{A}<60.0, preferably the ratio Li_{B}/Li_{A}<30.0, more preferably the ratio Li_{B}/Li_{A}<10.0; and
the ratio Li_{B}/Ti_{B}<100.0, preferably preferably the ratio Li_{B}/Ti_{B}<30.0, most preferably the ratio Li_{B}/Ti_{B}<10.0.

Certain preferred embodiments concern the positive electrode active material of the invention, wherein
the ratio Ti_{B}/Ti_{A} is in the range of 50.0 and 1000, preferably the ratio Ti_{B}/Ti_{A} is in the range of 75.0 and 500.0, more preferably the ratio Ti_{B}/Ti_{A} is in the range of 100.0 and 250.0;
the ratio Li_{B}/Li_{A} is between 2.0 and 60.0, preferably the ratio Li_{B}/Li_{A} is between 3.0 and 30.0, more preferably the ratio Li_{B}/Li_{A} is between 4.0 and 10.0; and
the ratio Li_{B}/Ti_{B} is between 2.0 and 60.0, preferably the ratio Li_{B}/Li_{A} is between 3.0 and 30.0, more preferably the ratio Li_{B}/Li_{A} is between 4.0 and 10.0.

### Morphology

In certain preferred embodiments the positive electrode active material of the invention comprises single-crystalline particles. In the context of the present invention a particle is considered to be single-crystalline if it consists of only one grain or at most five grains, preferably at most three grains, as observed by Scanning Electron Microscope (SEM) or Transmission Electron Microscope (TEM), preferably by observing grain boundaries of the particle. A grain boundary is defined as the interface between two grains in a particle, preferably wherein the atomic planes of the two grains are aligned to different orientations and meet as a crystalline discontinuity. As appreciated by the skilled person and in the context of the present invention, said positive electrode active material comprises single-crystalline particles in which 80% or more of the particles in a field of view of at least 45 μm×at least 60 μm (i.e. of at least 2700 μm²), preferably of: at least 100 μm×100 μm (i.e. of at least 10,000 μm²) in a SEM image are single-crystalline. For the determination of single-crystalline particles, grains which have a largest linear dimension as observed by SEM which is smaller than 20% of the median particle size D50 of the particle as determined by laser diffraction are ignored. This avoids the particles which are in essence single-crystalline, but which may have deposited on them several very small other grains, are inadvertently considered as not being single-crystalline.

In certain preferred embodiments the positive electrode active material of the invention comprises single-crystalline particles having a carbon content of higher than 0.020 wt. % by total weight of the positive electrode active material, preferably a carbon content higher than 0.025 wt. %, more preferably a carbon content higher than 0.030 wt. % by total weight of the positive electrode active material. In certain preferred embodiments the positive electrode active material of the invention comprises single-crystalline particles having a carbon content of less than 0.050 wt. % by total weight of the positive electrode active material, preferably a carbon content less than 0.040 wt. %, more preferably a carbon content less than 0.035 wt. % by total weight of the positive electrode active material. In certain preferred embodiment the positive electrode active material of the invention comprises single-crystalline particles having a carbon content in the range of 0.020 wt. % and 0.050 wt. % by total weight of the positive electrode active material, preferably a carbon content in the range of 0.025 wt. % and 0.040 wt. %, more preferably a carbon content in the range of 0.030 wt. % 0.035 wt. % by total weight of the positive electrode active material.

In certain preferred embodiments the positive electrode active material of the invention comprises single-crystalline particles, wherein the ratio Li_{B}/Li_{A}>2.0, preferably the ratio Lis/Li_{A}>2.5, more preferably the ratio Li_{b}/Li_{A}>3.0. In certain preferred embodiments the positive electrode active material of the invention comprises single-crystalline particles, wherein the ratio Li_{b}/Li_{A}<8.0, preferably the ratio Li_{B}/Li_{A}<7.0, more preferably the ratio Li_{B}/Li_{A}<6.0. In certain preferred embodiments the positive electrode active material of the invention comprises single-crystalline particles, wherein the ratio Li_{B}/Li_{A} is in the range of 2.0 and 8.0, preferable the ratio Li_{B}/Li_{A} is in the range of 2.5 and 7.0, more preferably the ratio Li_{B}/Li_{A} is in the range of 3.0 and 6.0.

In certain preferred embodiments the positive electrode active material of the invention comprises single-crystalline particles, wherein the ratio Li_{B}/Ti_{B}>2.0, preferably the ratio Li_{B}/Ti_{B}>2.5, more preferably the ratio Li_{B}/Ti_{B}>3.0. In certain preferred embodiments the positive electrode active material of the invention comprises single-crystalline particles, wherein the ratio Li_{B}/Ti_{B}<7.0, preferably the ratio Li_{B}/Ti_{B}<6.0, more preferably the ratio Li_{B}/Ti_{B}<5.0. In certain preferred embodiments the positive electrode active material of the invention comprises single-crystalline particles, wherein the ratio Li_{B}/Ti_{B} is in the range of 2.0 and 7.0, preferably the ratio Li_{B}/Ti_{B} is in the range of 2.5 and 6.0, more preferably the ratio Li_{B}/Ti_{B} is in the range of 3.0 and 5.0.

Certain preferred embodiments concern the positive electrode active material of the invention
comprising single-crystalline particles,
having a carbon content in the range of 0.020 wt. % and 0.50 wt. % by total weight of the positive electrode active material, preferably a carbon content in the range of 0.025 wt. % and 0.040 wt. %, more preferably a carbon content in the range of 0.030 wt. % and 0.050 wt. % by total weight of the positive electrode active material, and
wherein the ratio Li_{B}/Li_{A} is in the range of 2.0 and 8.0, preferable the ratio Li_{B}/Li_{A} is in the range of 2.5 and 7.0, more preferably the ratio Li_{B}/Li_{A} is in the range of 3.0 and 6.0.

Certain preferred embodiments concern the positive electrode active material of the invention
comprising single-crystalline particles,
having a carbon content in the range of 0.020 wt. % and 0.50 wt. % by total weight of the positive electrode active material, preferably a carbon content in the range of 0.025 wt. % and 0.040 wt. %, more preferably a carbon content in the range of 0.030 wt. % and 0.050 wt. % by total weight of the positive electrode active material, and
wherein the ratio Li_{B}/Ti_{B} is in the range of 2.0 and 7.0, preferably the ratio Li_{B}/Tig is in the range of 2.5 and 6.0, more preferably the ratio Lis/Ti_{B} is in the range of 3.0 and 5.0.

Certain preferred embodiments concern the positive electrode active material
comprising single-crystalline particles,
having a carbon content in the range of 0.020 wt. % and 0.50 wt. % by total weight of the positive electrode active material, preferably a carbon content in the range of 0.025 wt. % and 0.040 wt. %, more preferably a carbon content in the range of 0.030 wt. % 0.050 wt. % by total weight of the positive electrode active material,
wherein the ratio Li_{B}/Li_{A} is in the range of 2.0 and 8.0, preferable the ratio Li_{B}/Li_{A} is in the range of 2.5 and 7.0, more preferably the ratio Li_{B}/Li_{A} is in the range of 3.0 and 6.0, and wherein the ratio Li_{B}/Ti_{B} is in the range of 2.0 and 7.0, preferably the ratio Li_{B}/Tis is in the range of 2.5 and 6.0, more preferably the ratio Li_{b}/Ti_{B} is in the range of 3.0 and 5.0.

Certain preferred embodiments concern the positive electrode active material
comprising single-crystalline particles, and
wherein the particles have a Co content Co_{edge} as measured by cross-sectional EDS (CS-EDS) at an edge of the particles, wherein Co_{edge} is expressed as mol % relative to the sum of Ni, Mn, and Co content as measured by CS-EDS at the edge of the particles, wherein the particles have a Co content Co_{center} as measured by CS-EDS at a center of the particle, wherein Co_{center} is expressed as mol % relative to the sum of Ni, Mn, and Co content as measured by CS-EDS at the center of the particles, and wherein the ratio Co_{edge}/Co_{center}>1.10, preferably Co_{edge}/Co_{center}>1.20, more preferably Co_{edge}/Co_{center}>1.30, most preferably Co_{edge}/Co_{center}>1.50.

In the framework of the present invention, the edge of the particle is the boundary or external limit distinguishing the particle from its external environment. The center of the particle is a mid-point of the straight line, which is the longest among the straight lines connected by two points on the edges of the particle.

Certain preferred embodiments concern the positive electrode active material
comprising single-crystalline particles, and
wherein the particles have an AI content AI_{A} defined as

$$\frac{c}{( x + y + z + c )} ,$$

wherein c is the content of AI as measured by XPS, and wherein the positive electrode active material has a AI content AI_{B}, wherein AIs is determined by XPS analysis, wherein AI_{B} is expressed as a molar fraction compared to the sum of molar fractions of Co, Mn, Ni and AI as measured by XPS analysis, wherein the ratio AI_{B}/AI_{A}>1.0, preferably the ratio AI_{B}/AI_{A}>2.0, more preferably the ratio AI_{B}/AI_{A}>2.5, even more preferably the ratio AI_{B}/AI_{A}>3.0, even more preferably the ratio AI_{B}/AI_{A}>3.5, most preferably the ratio AI_{B}/AI_{A}>4.0.

Certain preferred embodiments concern the positive electrode active material
comprising single-crystalline particles,
wherein the particles have a Co content Co_{edge} as measured by cross-sectional EDS (CS-EDS) at an edge of the particles, wherein Co_{edge} is expressed as mol % relative to the sum of Ni, Mn, and Co content as measured by CS-EDS at the edge of the particles, wherein the particles have a Co content Co_{center} as measured by CS-EDS at a center of the particle, wherein Co_{center} is expressed as mol % relative to the sum of Ni, Mn, and Co content as measured by CS-EDS at the center of the particles, and wherein the ratio Co_{edge}/Co_{center}>1.10, preferably Co_{edge}/Co_{center}>1.20, more preferably Co_{edge}/Co_{center}>1.30, most preferably Co_{edge}/Co_{center}>1.50, and

$$\frac{c}{( x + y + z + c )} ,$$

the content of AI as measured by XPS, and wherein the positive electrode active material has a AI content Al_{B}, wherein Al_{B} is determined by XPS analysis, wherein Al_{B} is expressed as a molar fraction compared to the sum of molar fractions of Co, Mn, Ni and AI as measured by XPS analysis, wherein the ratio AI_{B}/AI_{A}>1.0, preferably the ratio AI_{B}/AI_{A}>2.0, more preferably the ratio Als/AI_{A}>2.5, even more preferably the ratio AI_{B}/AI_{A}>3.0, even more preferably the ratio AI_{B}/AI_{A}>3.5, most preferably the ratio AI_{B}/AI_{A}>4.0.

In certain preferred embodiments of the invention and in the context of the present invention the single-crystalline particle as defined herein is a monolithic particle. As appreciated by the skilled person in these certain preferred embodiments all embodiments related to the single-crystalline particle equally apply to the monolithic particle as defined in the present invention.

In certain preferred embodiments the positive electrode active material of the invention comprises single particles and/or secondary particles, wherein each of the single particles consist of only one primary particle and each of the secondary particles consist of at least two primary particles and at most twenty primary particles as observed in a SEM image. Preferably, at least 30% of the particles, more preferably at least 50% of the particles, constituting the powder observed in a SEM image are the single particles and/or the secondary particles. The number of primary particles constituting the single particles and/or the secondary particles are determined in a field of view of at least 45 μm×at least 60 μm (i.e. of at least 2700 μm²), preferably of: at least 100 μm×100 μm (i.e. of at least 10,000 μm².

The particles in the image should be well distributed therefore avoiding overlap between particles. This can be achieved by pouring a small amount of powder sample to the adhesive attached on the SEM sample holder and blowing air to remove the excess powder. In the context of the present invention primary particles are distinguished from each other in a SEM image by observing grain boundaries between the primary particles. A grain boundary is defined as the interface between two primary particles, preferably wherein the atomic planes of the two primary particles are aligned to different orientations and meet as a crystalline discontinuity.

In certain preferred embodiments the positive electrode active material of the invention comprises the single and/or the secondary particles having a carbon content of higher than 0.020 wt. % by total weight of the positive electrode active material, preferably a carbon content higher than 0.025 wt. %, more preferably a carbon content higher than 0.030 wt. % by total weight of the positive electrode active material. In certain preferred embodiments the positive electrode active material of the invention comprises the single and/or the secondary particles having a carbon content of less than 0.050 wt. % by total weight of the positive electrode active material, preferably a carbon content less than 0.040 wt. %, more preferably a carbon content less than 0.035 wt. % by total weight of the positive electrode active material. In certain preferred embodiment the positive electrode active material of the invention comprises the single and/or the secondary particles having a carbon content in the range of 0.020 wt. % and 0.050 wt. % by total weight of the positive electrode active material, preferably a carbon content in the range of 0.025 wt. % and 0.040 wt. %, more preferably a carbon content in the range of 0.030 wt. % 0.035 wt. % by total weight of the positive electrode active material.

In certain preferred embodiments the positive electrode active material of the invention comprises the single and/or the secondary particles particles, wherein the ratio Li_{B}/Li_{A}>2.0, preferably the ratio Li_{B}/Li_{A}>2.5, more preferably the ratio Li_{B}/Li_{A}>3.0. In certain preferred embodiments the positive electrode active material of the invention comprises the single and/or the secondary particles, wherein the ratio Li_{b}/Li_{A}<8.0, preferably the ratio Li_{B}/Li_{A}<7.0, more preferably the ratio Li_{b}/Li_{A}<6.0. In certain preferred embodiments the positive electrode active material of the invention comprises the single and/or the secondary particles, wherein the ratio Li_{B}/Li_{A} is in the range of 2.0 and 8.0, preferable the ratio Li_{b}/Li_{A} is in the range of 2.5 and 7.0, more preferably the ratio Li_{b}/Li_{A} is in the range of 3.0 and 6.0.

In certain preferred embodiments the positive electrode active material of the invention comprises the single and/or the secondary particles, wherein the ratio Li_{B}/Ti_{B}>2.0, preferably the ratio Li_{b}/Ti_{B}>2.5, more preferably the ratio Li_{B}/Ti_{B}>3.0. In certain preferred embodiments the positive electrode active material of the invention comprises the single and/or the secondary particles, wherein the ratio Li_{B}/Ti_{B}<7.0, preferably the ratio Li_{B}/Ti_{B}<6.0, more preferably the ratio Li_{B}/Ti_{B}<5.0. In certain preferred embodiments the positive electrode active material of the invention comprises the single and/or the secondary particles, wherein the ratio Li_{B}/Ti_{B} is in the range of 2.0 and 7.0, preferably the ratio Li_{b}/Ti_{B} is in the range of 2.5 and 6.0, more preferably the ratio Li_{b}/Ti_{B} is in the range of 3.0 and 5.0.

Certain preferred embodiments concern the positive electrode active material of the invention
comprising the single and/or the secondary particles,
having a carbon content in the range of 0.020 wt. % and 0.50 wt. % by total weight of the positive electrode active material, preferably a carbon content in the range of 0.025 wt. % and 0.040 wt. %, more preferably a carbon content in the range of 0.030 wt. % and 0.050 wt. % by total weight of the positive electrode active material, and
wherein the ratio Li_{B}/Li_{A} is in the range of 2.0 and 8.0, preferable the ratio Li_{b}/Li_{A} is in the range of 2.5 and 7.0, more preferably the ratio Li_{B}/Li_{A} is in the range of 3.0 and 6.0.

Certain preferred embodiments concern the positive electrode active material of the invention
comprising the single and/or the secondary particles,
having a carbon content in the range of 0.020 wt. % and 0.50 wt. % by total weight of the positive electrode active material, preferably a carbon content in the range of 0.025 wt. % and 0.040 wt. %, more preferably a carbon content in the range of 0.030 wt. % and 0.050 wt. % by total weight of the positive electrode active material, and
wherein the ratio Li_{B}/Ti_{B} is in the range of 2.0 and 7.0, preferably the ratio Li_{B}/Ti_{B} is in the range of 2.5 and 6.0, more preferably the ratio Li_{B}/Ti_{B} is in the range of 3.0 and 5.0.

Certain preferred embodiments concern the positive electrode active material
comprising the single and/or the secondary particles,
having a carbon content in the range of 0.020 wt. % and 0.50 wt. % by total weight of the positive electrode active material, preferably a carbon content in the range of 0.025 wt. % and 0.040 wt. %, more preferably a carbon content in the range of 0.030 wt. % 0.050 wt. % by total weight of the positive electrode active material,
wherein the ratio Li_{B}/Li_{A} is in the range of 2.0 and 8.0, preferable the ratio Li_{B}/Li_{A} is in the range of 2.5 and 7.0, more preferably the ratio Li_{B}/Li_{A} is in the range of 3.0 and 6.0, and
wherein the ratio Li_{B}/Ti_{B} is in the range of 2.0 and 7.0, preferably the ratio Li_{B}/Ti_{B} is in the range of 2.5 and 6.0, more preferably the ratio Li_{B}/Ti_{B} is in the range of 3.0 and 5.0.

Certain preferred embodiments concern the positive electrode active material
comprising the single and/or the secondary particles, and
wherein the particles have a Co content Co_{edge} as measured by cross-sectional EDS (CS-EDS) at an edge of the particles, wherein Co_{edge} is expressed as mol % relative to the sum of Ni, Mn, and Co content as measured by CS-EDS at the edge of the particles, wherein the particles have a Co content Co_{center} as measured by CS-EDS at a center of the particle, wherein Co_{center} is expressed as mol % relative to the sum of Ni, Mn, and Co content as measured by CS-EDS at the center of the particles, and wherein the ratio Co_{edge}/Co_{center}>1.10, preferably Co_{edge}/Co_{center}>1.20, more preferably Co_{edge}/Co_{center}>1.30, most preferably Co_{edge}/Co_{center}>1.50.

In the framework of the present invention, the edge of the particle is the boundary or external limit distinguishing the particle from its external environment. The center of the particle is a mid-point of the straight line, which is the longest among the straight lines connected by two points on the edges of the particle.

Certain preferred embodiments concern the positive electrode active material
comprising the single and/or the secondary particles, and
wherein the particles have an AI content AI_{A} defined as

$$\frac{c}{( x + y + z + c )} ,$$

wherein c is the content of AI as measured by XPS, and wherein the positive electrode active material has a AI content Al, wherein AI is determined by XPS analysis, wherein AI_{B} is expressed as a molar fraction compared to the sum of molar fractions of Co, Mn, Ni and AI as measured by XPS analysis, wherein the ratio AI_{B}/AI_{A}>1.0, preferably the ratio AI_{B}/AI_{A}>2.0, more preferably the ratio Als/AI_{A}>2.5, even more preferably the ratio AI_{B}/AI_{A}>3.0, even more preferably the ratio AI_{B}/AI_{A}>3.5, most preferably the ratio AI_{B}/AI_{A}>4.0.

Certain preferred embodiments concern the positive electrode active material
comprising the single and/or the secondary particles,
wherein the particles have a Co content Co_{edge} as measured by cross-sectional EDS (CS-EDS) at an edge of the particles, wherein Co_{edge} is expressed as mol % relative to the sum of Ni, Mn, and Co content as measured by CS-EDS at the edge of the particles, wherein the particles have a Co content Co_{center} as measured by CS-EDS at a center of the particle, wherein Co_{center} is expressed as mol % relative to the sum of Ni, Mn, and Co content as measured by CS-EDS at the center of the particles, and wherein the ratio Co_{edge}/Co_{center}>1.10, preferably Co_{edge}/Co_{center}>1.20, more preferably Co_{edge}/Co_{center}>1.30, most preferably Co_{edge}/Co_{center}>1.50, and
wherein the particles have an AI content AI_{A} defined as

$$\frac{c}{( x + y + z + c )} ,$$

wherein c is the content of AI as measured by XPS, and wherein the positive electrode active material has a AI content AI_{B}, wherein AIs is determined by XPS analysis, wherein AI_{B} is expressed as a molar fraction compared to the sum of molar fractions of Co, Mn, Ni and AI as measured by XPS analysis, wherein the ratio AI_{B}/AI_{A}>1.0, preferably the ratio AI_{B}/AI_{A}>2.0, more preferably the ratio AI_{B}/AI_{A}>2.5, even more preferably the ratio AI_{B}/AI_{A}>3.0, even more preferably the ratio AI_{B}/AI_{A}>3.5, most preferably the ratio AI_{B}/AI_{A}>4.0.

In certain preferred embodiment, said positive electrode active material of the invention comprises polycrystalline particles. As appreciated by the skilled person the polycrystalline particles are agglomerated by 5 or more single-crystalline particles, preferably 10 or more single-crystalline particles, more preferably 50 or more single-crystalline particles. This can be observed in proper microscope techniques like Scanning Electron Microscope (SEM) by observing grain boundaries. Agglomeration of the single-crystalline particles to the polycrystalline particles occurs under a post-treatment step such as a thermal treatment step.

In certain preferred embodiments the polycrystalline particles are agglomerated by more than 20 primary particles, preferably 50 or more primary particles, more preferably 100 or more primary particles. Hence, in certain preferred embodiments said positive electrode active material is a powder comprising polycrystalline particles, wherein each of the polycrystalline particles consist of more than 20 primary particles, preferably 50 or more primary particles, more preferably 100 or more primary particle as observed in a SEM image.

Preferably, at least 30% of the particles, more preferably at least 50% of the particles, constituting the powder observed in a SEM image are polycrystalline particles. The number of primary particles constituting the polycrystalline particles are determined in a field of view of at least 45 μm×at least 60 μm (i.e. of at least 2700 μm²), preferably of: at least 100 μm×100 μm (i.e. of at least 10,000 μm². The particles in the image should be well distributed therefore avoiding overlap between particles. This can be achieved by pouring a small amount of powder sample to the adhesive attached on the SEM sample holder and blowing air to remove the excess powder.

In certain preferred embodiments the positive electrode active material of the invention comprises polycrystalline particles having a carbon content of higher than 0.035 wt. % by total weight of the positive electrode active material, preferably a carbon content higher than 0.040 wt. %, more preferably a carbon content higher than 0.045 wt. % by total weight of the positive electrode active material. In certain preferred embodiments the positive electrode active material of the invention comprises polycrystalline particles having a carbon content of less than 0.075 wt. % by total weight of the positive electrode active material, preferably a carbon content less than 0.070 wt. %, more preferably a carbon content less than 0.065 wt. % by total weight of the positive electrode active material. In certain preferred embodiment the positive electrode active material of the invention comprises polycrystalline particles having a carbon content in the range of 0.035 wt. % and 0.075 wt. % by total weight of the positive electrode active material, preferably a carbon content in the range of 0.040 wt. % and 0.070 wt. %, more preferably a carbon content in the range of 0.045 wt. % 0.065 wt. % by total weight of the positive electrode active material.

In certain preferred embodiments the positive electrode active material of the invention comprises polycrystalline particles, wherein the ratio Li_{B}/Li_{A}>3.0, preferably the ratio Li_{B}/Li_{A}>3.5, more preferably the ratio Li_{B}/Li_{A}>4.0. In certain preferred embodiments the positive electrode active material of the invention comprises polycrystalline particles, wherein the ratio Li_{B}/Li_{A}<10.0, preferably the ratio Li_{B}/Li_{A}<9.0, more preferably the ratio Li_{b}/Li_{A}<8.5. In certain preferred embodiments the positive electrode active material of the invention comprises polycrystalline particles, wherein the ratio Li_{b}/Li_{A} is in the range of 3.0 and 10.0, preferable the ratio Li_{B}/Li_{A} is in the range of 3.5 and 9.0, more preferably the ratio Li_{b}/Li_{A} is in the range of 4.0 and 8.5.

In certain preferred embodiments the positive electrode active material of the invention comprises polycrystalline particles, wherein the ratio Li_{B}/Ti_{B}>4.0, preferably the ratio Li_{b}/Ti_{B}>5.0, more preferably the ratio Li_{B}/Ti_{B}>6.0. In certain preferred embodiments the positive electrode active material of the invention comprises polycrystalline particles, wherein the ratio Li_{B}/Ti_{B}<12.0, preferably the ratio Li_{B}/Ti_{B}<11.0, more preferably the ratio Li_{B}/Ti_{B}<10.0. In certain preferred embodiments the positive electrode active material of the invention comprises polycrystalline particles, wherein the ratio Li_{B}/Ti_{B} is in the range of 4.0 and 12.0, preferably the ratio Li_{B}/Ti_{B} is in the range of 5.0 and 11.0, mor preferably the ratio Li_{B}/Ti_{B} is in the range of 6.0 and 10.0.

Certain preferred embodiments concern the positive electrode active material of the invention
comprising polycrystalline particles,
having a carbon content in the range of 0.035 wt. % and 0.075 wt. % by total weight of the positive electrode active material, preferably a carbon content in the range of 0.040 wt. % and 0.070 wt. %, more preferably a carbon content in the range of 0.045 wt. % 0.065 wt. % by total weight of the positive electrode active material, and
wherein the ratio Li_{b}/Li_{A} is in the range of 3.0 and 10.0, preferable the ratio Li_{B}/Li_{A} is in the range of 3.5 and 9.0, more preferably the ratio Li_{B}/Li_{A} is in the range of 4.0 and 8.5.

Certain preferred embodiments concern the positive electrode active material of the invention
comprising polycrystalline particles,
having a carbon content in the range of 0.035 wt. % and 0.075 wt. % by total weight of the positive electrode active material, preferably a carbon content in the range of 0.040 wt. % and 0.070 wt. %, more preferably a carbon content in the range of 0.045 wt. % 0.065 wt. % by total weight of the positive electrode active material, and
the ratio Li_{B}/Ti_{B} is in the range of 4.0 and 12.0, preferably the ratio Li_{B}/Ti_{B} is in the range of 5.0 and 11.0, mor preferably the ratio Li_{b}/Ti_{B} is in the range of 6.0 and 10.0.

Certain preferred embodiments concern the positive electrode active material of the invention
comprising polycrystalline particles,
having a carbon content in the range of 0.035 wt. % and 0.075 wt. % by total weight of the positive electrode active material, preferably a carbon content in the range of 0.040 wt. % and 0.070 wt. %, more preferably a carbon content in the range of 0.045 wt. % 0.065 wt. % by total weight of the positive electrode active material,
wherein the ratio Li_{B}/Li_{A} is in the range of 3.0 and 10.0, preferable the ratio Li_{B}/Li_{A} is in the range of 3.5 and 9.0, more preferably the ratio Li_{B}/Li_{A} is in the range of 4.0 and 8.5, and
the ratio Li_{B}/Ti_{B} is in the range of 4.0 and 12.0, preferably the ratio Li_{B}/Ti_{B} is in the range of 5.0 and 11.0, mor preferably the ratio Li_{b}/Ti_{B} is in the range of 6.0 and 10.0.

Certain preferred embodiments concern the positive electrode active material of the invention comprising single-crystalline particles having a primary particle median D50 value of less than 10 μm, preferably less than 8 μm, more preferably less than 5 μm. Certain preferred embodiments concern the positive electrode active material of the invention comprising single-crystalline particles having a primary particle median D50 value of more than 1 μm, preferably more than 2 μm, more preferably more than 3 μm. Certain preferred embodiments concern the positive electrode active material of the invention comprising single-crystalline particles having a primary particle median D50 value between 1 and 10 μm, preferably between 2 and 8 μm, more preferably between 3 and 5 μm. As appreciated by the skilled person the particle size distribution (PSD) D50 of the positive electrode active material powder is measured by laser diffraction particle size analysis. For example, but not limiting to the invention, the particle median D50 can be measured using a Malvern Mastersizer 3000.

Certain preferred embodiments concern the positive electrode active material of the invention comprising the single particles and/or secondary particles having a particle median D50 value of less than 10 μm, preferably less than 8 μm, more preferably less than 5 μm. Certain preferred embodiments concern the positive electrode active material of the invention comprising the single particles and/or secondary particles having a particle median D50 value of more than 1 μm, preferably more than 2 μm, more preferably more than 3 μm. Certain preferred embodiments concern the positive electrode active material of the invention comprising the single particles and/or secondary particles having a particle median D50 value between 1 and 10 μm, preferably between 2 and 8 μm, more preferably between 3 and 5 μm. As appreciated by the skilled person the particle size distribution (PSD) D50 of the positive electrode active material powder is measured by laser diffraction particle size analysis. For example, but not limiting to the invention, the particle median D50 can be measured using a Malvern Mastersizer 3000. Preferably the particle median D50 is a volume median particle size.

Certain preferred embodiments concern the positive electrode active material of the invention comprising polycrystalline particles having a secondary particle median D50 value of less than 10 μm, preferably less than 8 μm, more preferably less than 5 μm. Certain preferred embodiments concern the positive electrode active material of the invention comprising polycrystalline particles having a secondary particle median D50 value of more than 1 μm, preferably more than 2 μm, more preferably more than 3 μm. Certain preferred embodiments concern the positive electrode active material of the invention comprising polycrystalline particles having a secondary particle median D50 value between 1 and 10 μm, preferably between 2 and 8 μm, more preferably between 3 and 5 μm. As appreciated by the skilled person the particle size distribution (PSD) D50 of the positive electrode active material powder is measured by laser diffraction particle size analysis. For example, but not limiting to the invention, the particle median D50 can be measured using a Malvern Mastersizer 3000. Preferably the particle median D50 is a volume median particle size.

### Method

In a second aspect the invention provides a method for manufacturing a positive electrode active material, wherein said method comprises:
preparing a slurry of a lithium transition metal-based oxide compound, a first source of lithium, water and an alcohol,
mixing said slurry with a source of Ti, and
heating the mixture at a temperature between 250 °C and less than 500 °C for a time between 1 hour and 20 hours so as to obtain the positive electrode active material.

In a highly preferred embodiment of the method for manufacturing a positive electrode active material of the invention the positive electrode active material is according to the first aspect of the invention. As appreciated by the skilled person, in case the method for manufacturing a positive electrode active material of the invention affords the positive electrode material according to the first aspect of the invention, all embodiments directed to the positive electrode active material according to the first aspect of the invention apply mutatis mutandis to the method for manufacturing the positive electrode active material according to the first aspect of the invention. For example, the various embodiments relating to the identity and amounts of Li, M′, Ti_{A}, Ti_{B}, Li_{A} and Li_{B} as explained herein in the context of the positive electrode active material are equally applicable to the method for the preparation of the positive electrode active material.

In a preferred embodiment of the method the lithium transition metal-based oxide compound comprising Li, M′ and oxygen, wherein M′ comprises Ni, Mn, Co, Ti and D, wherein D is at least one element of the group consisting of: Al, B, Ba, Ca, Cr, Fe, Mg, Mo, Nb, S, Si, Sr, V, W, Y, Zn, and Zr; preferably Al, B, Cr, Nb, S, Si, Y, Zr and W; more preferably B, Nb, Zr and W. Preferably, the lithium transition metal-based oxide used is also typically prepared according to a lithiation process, which is the process wherein a mixture of a transition metal oxide precursor and a second source of lithium is heated at a temperature preferably of at least 500 °C and at most 1000 °C. Typically, the transition metal precursor is prepared by co-precipitation of one or more transition metal sources, such as salts, preferably sulfates or nitrates, more preferably sulfates; of the elements Ni, Mn and/or Co, in the presence of an alkali compound, such as an alkali hydroxide e.g. sodium hydroxide and/or ammonia. Preferably, the second source of lithium is metallic lithium or a lithium salt, preferably a lithium salt such as LiOH. Optionally, the lithium transition metal-based oxide compound comprises single-crystalline particles or single and/or secondary particles as explained herein and is further mixed with a source of Co, such as Co₃O₄, and a third source of lithium, preferably the third source of lithium is metallic lithium or a lithium salt, preferably a lithium salt such as LiOH, wherein the source of Co has a Co content in the range of 1.0 to 2.0 mol %, relative to the sum of Ni, Mn and Co, and the source of Li has a Li content in the range of 5.0 to 10 mol %, relative to the sum of Ni, Mn and Co. Optionally, the lithium transition metal-based oxide compound is further crushed and sieved with alumina in an amount of 250 to 750 ppm, relative to the total amount of positive electrode active material.

In a preferred embodiment of the method the first source of Li is metallic lithium or a lithium salt, preferably a lithium salt such as LiOH.

In a preferred embodiment the slurry has a solid content of more than 40 wt. % (by total weight of the slurry), preferably a solid content of more than 50 wt. %, more preferably a solid of more than 55 wt. % (by total weight of the slurry). In a preferred embodiment the slurry has a solid content of less than 80 wt. % (by total weight of the slurry), preferably a solid content of less than 70 wt. %, more preferably a solid content of less than 65 wt. % (by total weight of the slurry). In a preferred embodiment the slurry has a solid content in the range of 40 wt. % to 80 wt. % (by total weight of the slurry), preferably a solid content in the range of 50 wt. % to 70 wt. %, more preferably a solid content in the range of 55 wt. % to 65 wt. % (by total weight of the slurry).

In a preferred embodiment of the method the alcohol is methanol, ethanol, propanol, butanol or combination thereof, preferably ethanol.

In a preferred embodiment of the method the molar ratio of Li present in the first source of Li to Ti present in the source of Ti is in the range of 5:1 tot 1:3, preferably in the range of 4:1 to 1:2, more preferably in the range of 3:1 to 1:1, such as about 2:1.

In a preferred embodiment of the method the molar ratio of water to Ti present in the source of Ti is in the range of 5:1 tot 1:3, preferably in the range of 4:1 to 1:2, more preferably in the range of 3:1 to 1:1, such as about 2:1.

In a preferred embodiment of the method the molar ratio of water to Li present in the first source of Li is in the range of 4:1 tot 1:4, preferably in the range of 3:1 to 1:3, more preferably in the range of 2:1 to 1:2, such as about 1:1.

In a preferred embodiment the amount of water in the slurry is between 0.5 mol % to 25.0 mol %, with respect to metal content in the lithium transition metal oxide compound, preferably between 0.7 mol % to 10.0 mol %, more preferably between 1 mol % to 5 mol %, with respect to metal content in the lithium transition metal oxide compound.

In a preferred embodiment the amount of Li present in the first source of lithium in the slurry is between 0.5 mol % to 25.0 mol %, with respect to metal content in the lithium transition metal oxide compound, preferably between 0.7 mol % to 10.0 mol %, more preferably between 1.0 mol % to 5.0 mol %, with respect to metal content in the lithium transition metal oxide compound.

In a preferred embodiment the amount of Ti present in the source of titanium in the slurry is between 0.1 mol % to 10.0 mol %, with respect to metal content in the lithium transition metal oxide compound, preferably between 0.25 mol % to 5.0 mol %, more preferably between 0.5 mol % to 1.5 mol %, with respect to metal content in the lithium transition metal oxide compound. In a preferred embodiment, the source of Ti is a Ti-alkoxide, preferably Ti-ethoxide, Ti-propoxide or Ti-butoxide, more preferably Ti-propoxide or Ti-isopropoxide such as Ti (IV)propoxide or Ti (IV)-isopropoxide. In a preferred embodiment the Ti-alkoxide is mixed as a solid with the mixture. Alternatively, the Ti-alkoxide is mixed as a solution with the slurry, wherein the solution comprises the Ti-alkoxide and a further alcohol, wherein the alkoxide group is a conjugate base of the further alcohol. For example, the Ti-alkoxide is Ti (IV)-propoxide, which is dissolved in propanol. Typically, the solution comprises 50-90 wt. % of the Ti-alkoxide by total weight of the solution. Examples of such a solution are a 70 wt. % Ti (IV)isopropoxide in 1-propanol or a 80 wt. % Ti (IV)-butoxide in 1-butanol.

In a preferred embodiment of the method is the heating of the mixture
at a temperature between 275 °C and 450 °C, preferably between 300 and 400 °C, more preferably between 325 and 375 °C; and
at a time between 2 hours and 15 hours, preferably between 3 hours and 10 hours, more preferably between 4 hours and 7 hours.

A preferred embodiment of the method is the heating of the mixture under an oxidizing atmosphere. Preferably, the oxidizing atmosphere comprises oxygen, such as air, or consists of oxygen.

In a more preferred embodiment the heating occurs in a furnace.

In certain preferred embodiments, the method comprises a further step, before heating said mixture, of filtering and drying said mixture. Preferably, said drying is done under vacuum, vacuum heating or under the constant flow of N₂ gas for at least 4 hours and at most 20 hours. As appreciated by the skilled person, filtering of said mixture is achieved by conventional filtration techniques known in the art.

In certain preferred embodiments, the method comprises a further step, before heating said mixture, of drying said mixture. Preferably, said drying is done under vacuum, vacuum heating or under the constant flow of N₂ gas for at least 4 hours and at most 20 hours.

### Product-by-Process

In a third aspect the invention concerns the positive electrode active material obtainable by the method according to the second aspect of the invention.

As appreciated by the skilled person all embodiments directed to the positive electrode active material according to the first aspect of the invention and/or the method according to the second aspect of the invention apply mutatis mutandis to the positive electrode active obtainable by the method according to the invention. For example, the various embodiments relating to the identity and amounts of Li, M′, Ti_{A}, Ti_{B}, Li_{A} and Li_{B} as explained herein in the context of the positive electrode active material are equally applicable to the positive electrode active material obtainable by the method for the preparation of the positive electrode active material.

### Battery

In a fourth aspect the invention concerns a battery comprising the positive electrode active material according to the first aspect of the invention and/or the positive electrode active material obtainable by the method according to the third aspect of the invention.

In a preferred embodiment the battery is a solid-state battery. Preferably the solid-state battery comprises a sulfide-based electrolyte. Preferably said electrolyte is a sulfide based solid electrolyte, more preferably the electrolyte comprises Li, P, and S. Typically, the following sulfur containing compounds of Li₆PS₅Cl (LPSCL), thio-LISICON (Li_{3.25}Ge_{0.25}P_{0.75}S₄), Li₂S—P₂S₅-LiCl, Li₂S—SiS₂, LiI-Li₂S—SiS₂, Li₂S—P₂S₅-LiCl, Li₂S—SiS₂, LiI-Li₂S—SiS₂, LiI-Li₂S—P₂S₅, LiI—Li₂SP₂O₅, LiI-Li₃PO₄—P₂S₅, Li₂S—P₂S₅, Li₃PS₄, Li₂P₃S₁₁, LiI-Li₂S-B₂S₃, Li₃PO₄-Li₂S—SiS₂, Li₃PO₄-Li₂S—SiS₂, Li₃PO₄-Li₂S—SiS₂, Li₁₀GeP₂S₁₂, Li_{9.54}Si_{1.74}P_{1.44}S_{11.7}Cl_{0.3}, and/or Li₂P₃S₁₁ may be suitably used. In a highly preferred embodiment the battery is a sulfide solid-state battery.

Preferably, the solid-state battery further comprises an anode comprising anode active material. Suitable electrochemically active anode materials are those known in the art. For example, the anode may comprise graphitic carbon, metallic lithium or a metal alloy comprising lithium, such as Li—In alloy, as the anode active material.

In a preferred embodiment the battery according to the invention has an efficiency of at least 88%, preferably at least 90%, more preferably at least 92%, most preferably at least 94%. As appreciated by the skilled person the efficiency of the battery is determined as explained under point E2) of the Examples.

In a preferred embodiment the battery according to the invention has first discharge capacity of at least 200 mAh/g, more preferably of at least 205 mAh/g, most preferably of at least 210 mAh/g. As understood by the skilled person the first discharge capacity (DQ1) is measured in constant current mode (CC) at C rate of 0.1 C in voltage range: 4.3 V to 2.5 V (Li/Li⁺) or 3.7 V to 1.9 V (InLi/Li⁺).

### Use

In a fifth aspect the present invention concerns a use of the positive electrode active material according to the first aspect of the invention and/or the positive electrode active material obtainable by the method according to the third aspect of the invention in a battery.

A preferred embodiment is the use of the positive electrode active material in a battery, preferably a solid-state-battery, more preferably a sulfide solid-state-battery, to increase the efficiency of the battery and/or to increase the first discharge capacity of said battery.

In a sixth aspect the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

### EXAMPLES

### Experimental Test Used in the Examples

The following analysis methods are used in the Examples:

### A) ICP Analysis

The amount of Li, Ni, Mn, Co, and Ti in the positive electrode active material powder is measured with the Inductively Coupled Plasma (ICP-OES) method by using an Agilent ICP 720-ES. 2 grams of powder sample is dissolved into 10 ml of high purity hydrochloric acid (at least 37 wt % of HCl with respect to the total weight of solution) in an Erlenmeyer flask. The flask is covered by a glass and heated on a hot plate at 380 °C until complete dissolution of the powder. After being cooled to room temperature, the solution of the Erlenmeyer flask is poured into a 250 mL volumetric flask. Afterwards, the volumetric flask is filled with deionized water up to the 250 mL mark, followed by complete homogenization. An appropriate amount of solution is taken out by pipette and transferred into a 250 mL volumetric flask for the 2nd dilution, where the volumetric flask is filled with internal standard and 10% hydrochloric acid up to the 250 mL mark and then homogenized. Finally, this 50 mL solution is used for ICP-OES measurement.

### B) Particle Size

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring is applied, and an appropriate surfactant is introduced. D50 is defined as the particle size at 50% of the cumulative volume % distributions obtained from the Malvern Mastersizer 3000 with Hydro MV measurements.

### C) X-Ray Photoelectron Spectroscopy Analysis

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of the positive electrode active material powder particles, XPS measurement is carried out using a Thermo K-α+ spectrometer (Thermo Scientific). Monochromatic AI Kα radiation (hu=1486.6 eV) is used with a spot size of 400 μm and measurement angle of 45°. A wide survey scan to identify elements present at the surface is conducted at 200 eV pass energy. Cis peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version2.3.19PR1.0 (Casa Software) using a Shirley-type background treatment and Scofield sensitivity factors. The fitting parameters are according to Table 1a. Line shape GL (30) is the Gaussian/Lorentzian product formula with 70% Gaussian line and 30% Lorentzian line.

TABLE 1a
XPS fitting parameter for Ni2p3, Mn2p3, Co2p3, and Ti2p.

| | Sensitivity | Fitting range | | |
|---|---|---|---|---|
| Element | factor | (eV) | Defined peak(s) | Line shape |
| Ni | 14.61 | 851.3 ± 0.1-868.4 ± 0.1 | Ni2p3, Ni2p3 satellite | GL(30) |
| Mn | 9.17 | 639.5 ± 0.1-650.0 ± 0.1 | Mn2p3, Mn2p3 satellite | GL(30) |
| Co | 12.62 | 776.7 ± 0.4-792.5 ± 0.4 | Co2p3 peak 1, Co2p3 | GL(30) |
| | | | peak 2, Co2p3 satellite | |
| Ti | 7.81 | 451.1 ± 0.1-467.0 ± 0.1 | Ti2p3 (IV), Ti2p1 (IV), | GL(30) |
| | | | Ti2p3 (III), Ti 2p1 (III), | |
| | | | Ti2p3 (II), Ti 2p1 (II), | |
| Li | 0.057 | 52.3 ± 0.1-57.3 ± 0.1 | Li1s peak 1, Li1s peak 2 | GL(30) |

For Ti and Co peaks, constraints are set for each defined peak according to Table 1b.

TABLE 1b
XPS fitting constraints for peaks fitting.

| | | Fitting range | | |
|---|---|---|---|---|
| | | constraint | FWHM constraint | |
| Element | Defined peak | (eV) | (eV) | Area constraint |
| Ti | Ti2p3 (IV) | 456.0-460.0 | 0.2-2.5 | No constraint set |
| | Ti2p1 (IV) | Ti2p3 (IV) + 5.72 | 0.2-2.5 | 50% of Ti2p3 (IV) |
| | Ti2p3 (III) | Ti2p3 (IV) − 1.4 | 0.2-2.5 | No constraint set |
| | Ti2p1 (III) | Ti2p3 (IV) + 4.32 | 0.2-2.5 | 50% of Ti2p3 (III) |
| | Ti2p3 (II) | Ti2p3 (IV) − 3.2 | Equal to Ti2p3 (III) | No constraint set |
| | Ti2p1 (II) | Ti2p3 (IV) + 2.52 | Equal to Ti2p1 (III) | 50% of Ti2p3 (II) |
| Co | Co2p3 peak 1 | 776.0-780.9 | 0.5-4.0 | No constraint set |
| | Co2p3 peak 2 | 781.0-785.0 | 0.5-4.0 | No constraint set |
| | Co2p3 satellite | 786.2-792.0 | 0.5-4.0 | No constraint set |

The Ti and Li surface contents as determined by XPS are expressed as a molar fraction of Ti and Li in the surface layer of the particles divided by the total content of Ni, Mn, Co, and Ti in said surface layer. It is calculated as follows:

$$fraction of Ti = {Ti}_{B} = \frac{Ti ( at \% )}{Ni ( at \% ) + Mn ( at \% ) + Co ( at \% ) + Ti ( at \% )}$$

$$fraction of Li = {Li}_{B} = \frac{Li ( at \% )}{Ni ( at \% ) + Mn ( at \% ) + Co ( at \% ) + Ti ( at \% )} .$$

### D) Carbon Analyzer

The content of carbon of the positive electrode active material powder is measured by Horiba Emia-Expert carbon/sulfur analyzer. 1 gram of the positive electrode active material powder is placed in a ceramic crucible in a high frequency induction furnace. 1.5 gram of tungsten and 0.3 gram of tin as accelerators are added into the crucible as accelerators. The powder is heated at a programmable temperature wherein gases produced during the combustion are then analyzed by Infrared detectors. The analysis of CO₂ and CO determines carbon concentration.

### E) Sulfide Solid-State Battery Testing

### E1) Sulfide Solid-State Battery Preparation

### Positive Electrode Preparation:

For the preparation of a positive electrode, a slurry contains positive electrode active material powder, Li-P-S-CI based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode. The obtained positive electrode is punched with a diameter of 10 nm wherein the active material loading amount is around 4 mg/cm².

### Negative Electrode Preparation:

For the preparation of negative electrode, Li foil (diameter 3 mm, thickness 100 μm) is placed centered on the top of In foil (diameter 10 mm, thickness 100 μm) and pressed to form Li—In alloy negative electrode.

### Separator

For the preparation of separator which also has a function of the solid electrolyte in a battery, the Li-P-S-CI based solid electrolyte is pelletized with a pressure of 250 MPa to obtain 1 mm pellet thickness.

### Cell Assembly

A sulfide solid-state battery is assembled in an argon-filled glovebox with such order from bottom to top: positive electrode comprising AI current collector with the coated part on the top-separator-negative electrode with Li side on the top-Cu current collector. The stacked components are pressed together with a pressure of 250 MPa and placed in an external cage to prevent air exposure.

### E2) Testing Method

The testing method is a conventional “constant cut-off voltage” test. The conventional cell test in the present invention follows the schedule shown in Table 2. Each cell is cycled at 60 °C using a Toscat-3100 computer-controlled galvanostatic cycling station (from Toyo).

The schedule uses a 1C current definition of 160 mA/g. The initial charge capacity (CQ1) and discharge capacity (DQ1) are measured in constant current mode (CC) at C rate of 0.1 C in voltage range: 4.3 V to 2.5 V (Li/Li⁺) or 3.7 V to 1.9 V (InLi/Li⁺).

The efficiency EF is expressed in % as follows:

$$EF ( \% ) = \frac{DQ 1}{CQ 1} \times 100$$

TABLE 2
Cycling schedule for sulfide solid-state battery testing method

| Charge | | | | Discharge | | | |
|---|---|---|---|---|---|---|---|
| C | End | Rest | V/Li metal | C | End | Rest | V/Li metal |
| Rate | current | (min) | (V) | Rate | current | (min) | (V) |
| 0.1 | — | 30 | 4.3 | 0.1 | — | 30 | 2.5 |

The present invention is further illustrated in the following examples:

### Comparative Example 1

A monolithic positive electrode active material (i.e. a positive electrode active material comprising single and secondary particles) labelled as CEX1.1 was prepared according to the following steps:
Step 1) Transition metal oxidized hydroxide precursor preparation: a nickel-based transition metal oxidized hydroxide powder (TMH1) having a metal composition Ni_{0.85}Mn_{0.07}CO_{0.08} Was prepared by a co-precipitation process in a large-scale continuous stirred tank reactor (CSTR) with mixed nickel manganese cobalt sulfates, sodium hydroxide, and ammonia.
Step 2) First mixing: TMH1 prepared from Step 1) was mixed with LiOH in an industrial blender to obtain a first mixture having a lithium to metal M′ (Li/M′) ratio of 0.96.
Step 3) First heating: the first mixture from Step 2) was heated at 885 °C for 11 hours under an oxidizing atmosphere to obtain a first heated product.
Step 4) Wet bead milling: the first heated product from Step 3) was bead milled in a solution containing 0.5 mol % of Co with respect to the total molar contents of Ni, Mn, and Co in the first heated product followed by drying and sieving process to obtain a milled product. The bead milling solid to solution weight ratio was 6:4 and was conducted for 40 minutes.
Step 5) Drying: the milled product obtained from Step 4) was dried at 150 °C for 12 hours.
Step 6) Second mixing: the dried product obtained from Step 5) was mixed in an industrial blender with 1.5 mol % of Co from Co₃O₄ and 7.5 mol % of Li from LiOH, each with respect to the total molar contents of Ni, Mn, and Co in the milled product to obtain a second mixture.
Step 7) Second heating: the second mixture from Step 6) was heated at 760 °C for 10 hours under an oxidizing atmosphere followed by crushing and sieving with 500 ppm of alumina powder to obtain CEX1.1.

CEX1.2 is prepared by mixing CEX1.1 with 0.45 mol % Ti from TiO₂ and 0.90 mol % of Li from LiOH followed by heating under an oxidizing atmosphere at 350 °C for 6 hours.

### Example 1

A monolithic positive electrode active material (i.e. a positive electrode active material comprising single and secondary particles) labelled as EX1.1 was prepared according to the following steps:
Step 1) Ti solution preparation: 0.97 mol % of Ti from Ti-isopropoxide was dissolved in 4 grams of ethanol.
Step 2) Slurry preparation: 60 grams of CEX1.1 was mixed with 1.94 mol % of LiOH and 1.94 mol % of water, both relative to Ti, and 40 grams ethanol to form a slurry.
Step 3) Mixing: Ti solution prepared from Step 1) and slurry prepared from Step 2) were mixed and stirred for 15 hours at room temperature followed by filtering and drying at 80 °C in vacuum for 6 hours.
Step 4) Heating: the dried powder from Step 3) was heated at 350 °C for 5 hours under an oxygen atmosphere to obtain EX1.1 having M′ comprising Ni, Mn, Co, and Ti in a ratio Ni:Mn:Co:Ti of 0.84:0.07:0.09:0.010 as obtained by ICP-OES. EX1.1 has a D50 of 4 μm.

EX1.2 was prepared according to the same method as EX1.1, except that the 0.58 mol % of Ti from Ti-isopropoxide was used in Step 1) and 1.16 mol % of Li from LiOH and 1.97 mol % of H₂O were used in Step 2).

EX1.3 was prepared according to the same method as EX1.1, except that the 0.38 mol % of Ti from Ti-isopropoxide was used in Step 1) and 0.76 mol % of Li from LiOH and 1.90 mol % of H₂O were used in Step 2).

### Comparative Example 2

A polycrystalline positive electrode active material labelled as CEX2 was prepared according to the following steps:
Step 1) Transition metal oxidized hydroxide precursor preparation: a nickel-based transition metal oxidized hydroxide powder (TMH2) having a metal composition Ni_{0.83}Mn_{0.12}Co_{0.05} Was prepared by a co-precipitation process in a large-scale continuous stirred tank reactor (CSTR) with mixed nickel manganese cobalt sulfates, sodium hydroxide, and ammonia.
Step 2) First mixing: TMH2 prepared from Step 1) was mixed with LiOH in an industrial blender to obtain a first mixture having a lithium to metal M′ (Li/M′) ratio of 0.97.
Step 3) First heating: the first mixture from Step 2) was heated at 750 °C for 11 hours under an oxidizing atmosphere to obtain a first heated product.
Step 4) Second mixing: the first heated product was mixed with LiOH in an industrial blender to obtain a first mixture having a lithium to metal M′ (Li/M′) ratio of 1.02.
Step 5) Second heating: the second mixture from Step 4) was heated at 770 °C for 12 hours under an oxidizing atmosphere followed by crushing and sieving with to obtain CEX2.

### Example 2

A polycrystalline positive electrode active material labelled as EX2.1 was prepared according to the following steps:
Step 1) Ti solution preparation: 0.63 mol % of Ti from Ti-isopropoxide was dissolved in 4 grams of ethanol.
Step 2) Slurry preparation: 60 grams of CEX1.1 was mixed with 1.26 mol % of LiOH and 1.26 mol % of water, both relative to M′, and 40 grams ethanol to form a slurry.
Step 3) Mixing: Ti solution prepared from Step 1) and slurry prepared from Step 2) were mixed and stirred for 15 hours at room temperature followed by filtering and drying at 80 °C in vacuum for 6 hours.
Step 4) Heating: the dried powder from Step 3) was heated at 350 °C for 5 hours under an oxygen atmosphere to obtain EX2.1 having M′ comprising Ni, Mn, Co and Ti in a ratio Ni:Mn:Co:Ti of 0.83:0.12:0.05:0.006 as obtained by ICP-OES. EX2.1 has a D50 of 5.5 μm.

EX2.2 was prepared according to the same method as EX2.1, except that the 0.38 mol % of Ti from Ti-isopropoxide was used in Step 1) and 0.76 mol % of Li from LiOH and 0.76 mol % of H₂O were used in Step 2).

EX2.3 was prepared according to the same method as EX2.2, except that in Step 3) the mixture was dried using vacuum pump.

### Results

TABLE 3
Summary of the composition, surface area, and the corresponding
electrochemical properties of example and comparative examples.

| | | | | | | | | | Electrochemical | |
|---|---|---|---|---|---|---|---|---|---|---|
| | Composition | | | | Carbon | | | | property | |
| | Ni | Ti | XPS | | content | | | | DQ1 | EF |
| ID | (mol %) | (mol %) | Ti_{B}* | Li_{B}* | (wt. %) | Ti_{B}/Ti_{A} | Li_{B}/Li_{A} | Li_{B}/Ti_{B} | (mAh/g) | (%) |
| CEX1.1 | 84 | 0.0 | 0.0 | 4.2 | 0.022 | n.a** | 4.2 | n.a** | 192.0 | 85.3 |
| CEX1.2 | 84 | 0.54 | 0.12 | 7.4 | 0.040 | 21.6 | 7.4 | 63.9 | 195.3 | 83.0 |
| EX1.1 | 84 | 0.97 | 0.89 | 3.3 | 0.026 | 118.7 | 3.3 | 3.7 | 118.9 | 88.0 |
| EX1.2 | 84 | 0.58 | 0.82 | 4.0 | 0.031 | 151.2 | 4.0 | 4.9 | 209.3 | 92.5 |
| EX1.3 | 84 | 0.38 | 0.74 | 3.1 | 0.033 | 247.8 | 3.1 | 4.2 | 205.4 | 91.9 |
| CEX2 | 83 | 0.0 | 0.0 | 11.8 | 0.048 | n.a** | 11.8 | n.a** | 197.8 | 84.0 |
| EX2.1 | 83 | 0.63 | 0.84 | 8.2 | 0.057 | 111.6 | 8.1 | 9.8 | 215.6 | 94.5 |
| EX2.2 | 83 | 0.38 | 0.87 | 7.7 | 0.062 | 193.1 | 7.6 | 8.8 | 216.6 | 94.9 |
| EX2.3 | 83 | 0.38 | 0.63 | 4.0 | 0.061 | 140.2 | 4.0 | 6.4 | 213.5 | 94.5 |

*relative to molar contents of Ni, Mn, Co, and Ti
**n.a = not applicable

Table 3 summarizes the compositions of examples and comparative examples and their corresponding electrochemical property. The XPS analysis result Ti_{B} and Li_{B} shows atomic ratio (equivalent with molar ratio) of Li and Ti with respect to the total atomic fraction of Ni, Mn, Co, and Ti. The table also compares the result with that of ICP. The atomic ratio higher than 1 indicating said Li and Ti are enriched in the surface of the positive electrode active material as associated with the XPS measurement which signal is acquired from the first few nanometers (e.g. 1 nm to 10 nm) of the uppermost part of a sample, i.e. surface layer. On the other hand, Li and Ti atomic ratio from ICP measurement is obtained from the entire particles. Therefore, the ratio of XPS to ICP of higher than 1 indicates the presence of elements Li and Ti mostly on the surface of the positive electrode active material.

CEX1.1, CEX1.2, and EX1.1 to EX1.3 are monolithic positive electrode active material having Ni content 84 mol %. CEX1.1 is the core material and CEX1.2 is the CEX1.1 dry mixed with Ti material followed by heating. The difference in the process of Ti introduction by preparing Ti solution leads higher Ti_{B}, and Ti_{B}/Ti_{A} ratio in EX1.1 to EX1.3 in comparison with CEX1.2. It is further observed that the higher Ti content on the surface is linked with the improvement in the efficiency of a solid-state battery.

CEX2 and EX2.1 to EX2.3 are polycrystalline positive electrode active materials having a Ni content of 83 mol %. EX2.1 and EX2.2, prepared according to the method of the invention, show higher Ti content, Tis, and Tis/Ti_{A} ratio, and are connected to higher electrochemical cell efficiency, in comparison with CEX2. EX2.3, prepared according to the same method as EX2.2, except the filtration was replaced with evaporation. Both EX2.2 and EX2.3 having the same Ti content show similar electrochemical cell efficiency.

The invention illustrated the comparison between CEX1 and EX1, and CEX2 and EX2. All these samples show enhanced electrochemical cell efficiency linked to the higher Ti_{B} ratio of each comparative examples.

1-17. (canceled)

18. A positive electrode active material for solid-state batteries, wherein the positive electrode active material comprises Li, M′, and oxygen, wherein M′ comprises:
Ni in a content x, wherein 55.0 mol %≤x≤98.0 mol %,
Mn in a content y, wherein 0.0 mol %≤y≤45.0 mol %,
Co in a content z, wherein 0.0 mol %≤z≤45.0 mol %,
D in a content a, wherein 0.0 mol %≤a≤5.0 mol %, wherein D is at least one other element than Li, Ni, Mn, Co, Ti and O,
Ti in a content b, wherein 0.01 mol %≤b≤5.0 mol %,
wherein x, y, z, a, and b are measured by ICP-OES,
wherein x+y+z+a+b is 100.0 mol %,
wherein the positive electrode active material has a Ti content Ti_{A} defined as
$$\frac{b}{( x + y + z + b )} ,$$
wherein the positive electrode active material has a Ti content Ti_{B}, wherein Ti_{B} is determined by XPS analysis, wherein Ti_{B} is expressed as a molar fraction compared to the sum of molar fractions of Co, Mn, Ni, and Ti as measured by XPS analysis,
wherein the ratio Ti_{B}/Ti_{A}>25.0,
wherein the positive electrode active material has a Li content Li_{A}, wherein Li_{A} is determined by ICP analysis, wherein Li_{A} is expressed as a molar fraction compared to the sum of molar fractions of Co, Mn, Ni, and Ti as measured by ICP analysis,
wherein the positive electrode active material has a Li content Li_{B}, wherein Li_{B} is determined by XPS analysis, wherein Li_{B} is expressed as a molar fraction compared to the sum of molar fractions of Co, Mn, Ni, and Ti as measured by XPS analysis, and
wherein the ratio Li_{B}/Li_{A}>1.0.

19. The positive electrode active material according to claim 18, wherein D is at least one element selected from the group consisting of Al, B, Ba, Ca, Cr, Fe, Mg, Mo, Nb, S, Si, Sr, V, W, Y, Zn and Zr.

20. The positive electrode active material according to claim 19, wherein the ratio Li_{B}/Li_{A}>2.0.

21. The positive electrode active material according to claim 18, wherein the ratio Li_{B}/Ti_{B}>2.0.

22. The positive electrode active material according to claim 18, wherein the ratio Li_{B}/Ti_{B}<60.0.

23. The positive electrode active material according to claim 18, wherein the ratio Ti_{B}/Ti_{A}>50.0.

24. The positive electrode active material according to claim 18, wherein 60.0 mol %≤x≤95.0 mol %.

25. The positive electrode active material according to claim 18, wherein 0.05 mol %≤b≤2.5 mol %.

26. A method for manufacturing a positive electrode active material, wherein said method comprises:
preparing a slurry of a lithium transition metal-based oxide compound, a first source of lithium, water, and an alcohol,
mixing said slurry with a source of Ti, and
heating the mixture at a temperature between 250 °C and less than 500 °C for a time between 1 hour and 20 hours so as to obtain the positive electrode active material.

27. The method according to claim 26, wherein the method comprises a further step, before heating said mixture, of filtering and drying said mixture.

28. The method according to claim 26, wherein the method comprises a further step, before heating said mixture, of drying said mixture.

29. The method according to claim 26, wherein the source of Ti is Ti-propoxide or Ti-isopropoxide.

30. The method according to claim 26, wherein the amount of water in slurry is between 0.5 mol % to 25.0 mol %, with respect to the metal content in the lithium transition metal oxide compound.

31. The method according to claim 26, wherein a pH of the slurry >7.

32. A solid-state battery comprising the positive electrode active material according to claim 18.

33. Solid-state battery according to claim 32, wherein said solid-state battery comprises a sulfide based solid electrolyte comprising Li, P, and S.

1. A positive electrode active material for solid-state batteries, wherein the positive electrode active material comprises Li, M′, and oxygen, wherein M′ comprises:
Ni in a content x, wherein 55.0 mol %≤x≤98.0 mol %,
Mn in a content y, wherein 0.0 mol %≤y≤45.0 mol %,
Co in a content z, wherein 0.0 mol %≤z≤45.0 mol %,
D in a content a, wherein 0.0 mol %≤a≤5.0 mol %, wherein D is at least one other element than Li, Ni, Mn, Co, Ti and O,
Ti in a content b, wherein 0.01 mol %≤b≤5.0 mol %,
wherein x, y, z, a, and b are measured by ICP-OES,
wherein x+y+z+a+b is 100.0 mol %,
wherein the positive electrode active material has a Ti content Ti_{A} defined as
$$\frac{b}{( x + y + z + b )} ,$$
wherein the positive electrode active material has a Ti content Ti_{B}, wherein Ti_{B} is determined by XPS analysis, wherein Ti_{B} is expressed as a molar fraction compared to the sum of molar fractions of Co, Mn, Ni, and Ti as measured by XPS analysis,
wherein the ratio Ti_{B}/Ti_{A}>25.0,
wherein the positive electrode active material has a Li content Li_{A}, wherein Li_{A} is determined by ICP analysis, wherein Li_{A} is expressed as a molar fraction compared to the sum of molar fractions of Co, Mn, Ni, and Ti as measured by ICP analysis,
wherein the positive electrode active material has a Li content Li_{B}, wherein Li_{B} is determined by XPS analysis, wherein Li_{B} is expressed as a molar fraction compared to the sum of molar fractions of Co, Mn, Ni, and Ti as measured by XPS analysis, and wherein the ratio Li_{B}/Li_{A}>1.0.

2. Positive electrode active material according to claim 1, wherein D is at least one element selected from the group consisting of Al, B, Ba, Ca, Cr, Fe, Mg, Mo, Nb, S, Si, Sr, V, W, Y, Zn and Zr; preferably Al, B, Cr, Nb, S, Si, Y, Zr and W; more preferably B, Nb, Zr and W.

3. Positive electrode active material according to claim 2, wherein the ratio Li_{b}/Li_{A}>2.0, preferably the ratio Li_{B}/Li_{A}>3.0, more preferably the ratio Li_{B}/Li_{A}>4.0.

4. Positive electrode active material according to any one of claims 1-3, wherein the ratio Li_{B}/Ti_{B}>2.0, preferably the ratio Li_{B}/Ti_{B}>3.0, more preferably the ratio Li_{B}/Ti_{B}>4.0.

5. Positive electrode active material according to any one of the previous claims, wherein the ratio Li_{B}/Ti_{B}<60.0, preferably the ratio Li_{b}/Ti_{B}<30.0, more preferably Li_{B}/Ti_{B}<10.0.

6. Positive electrode active material according to any of the previous claims, wherein the ratio Ti_{B}/Ti_{A}>50.0, preferably the ratio Ti_{B}/Ti_{A}>75.0, more preferably the ratio Ti_{B}/Ti_{A}>100.0.

7. Positive electrode active material according to any of the previous claims, wherein 60.0 mol %≤x≤95.0 mol %, preferably 65.0 mol %≤x≤92.0 mol %, more preferably 70.0 mol %≤x≤90.0 mol %.

8. Positive electrode active material according to any of the previous claims, wherein 0.05 mol %≤b≤2.5 mol %, preferably 0.1 mol %≤b≤2.0 mol %, more preferably 0.2 mol %≤b≤1.5 mol %.

9. A method for manufacturing a positive electrode active material, preferably the positive electrode active material according to any one of claims 1-8, wherein said method comprises:
preparing a slurry of a lithium transition metal-based oxide compound, a first source of lithium, water, and an alcohol,
mixing said slurry with a source of Ti, and
heating the mixture at a temperature between 250 °C and less than 500 °C for a time between 1 hour and 20 hours so as to obtain the positive electrode active material.

10. The method according to claim 9, wherein the method comprises a further step, before heating said mixture, of filtering and drying said mixture.

11. The method according to claim 9, wherein the method comprises a further step, before heating said mixture, of drying said mixture.

12. The method according to any one of claims 9 to 11, wherein the source of Ti is Ti-propoxide or Ti-isopropoxide.

13. The method according to any of claims 9 to 12, wherein the amount of water in slurry is between 0.5 mol % to 25.0 mol %, with respect to the metal content in the lithium transition metal oxide compound, preferably between 0.7 mol % to 10.0 mol %, more preferably 1.0 mol % to 5.0 mol %.

14. The method of according to any of claims 9 to 13, wherein the pH of the slurry >7.

15. A solid-state battery comprising the positive electrode active material according to claims 1 to 8.

16. Solid-state battery according to claim 15, wherein said solid-state battery comprises a sulfide based solid electrolyte comprising Li, P, and S.

17. Use of the solid-state battery according to claim 15 or 16 in either one of a portable computer, a tablet, a mobile phone, an energy storage system, an electric vehicle or in a hybrid electric vehicle.
